(19) United States
(12) Patent Application Publication
(10) Pub. No.: US 2014/0102044 A1
(43) Pub. Date: Apr. 17, 2014

(54) APPARATUS AND METHOD FOR MANUFACTURE OF A SECONDARY PACKAGE

(71) Applicants: Michael Berglin, Malmo (SE); Nils-Olof Jönsson, Veberod (SE); Per Sundh, Lund (SE); Andreas Nilsson, Lund (SE)

(72) Inventors: Michael Berglin, Malmo (SE); Nils-Olof Jönsson, Veberod (SE); Per Sundh, Lund (SE); Andreas Nilsson, Lund (SE)

(73) Assignee: TETRA LAVAL HOLDINGSS & FINANCE S.A., Pully (CH)

(21) Appl. No.: 14/126,597

(22) PCT Filed: Aug. 17, 2012
(86) PCT No.: PCT/SE2012/050883

§ 371 Date: Dec. 16, 2013

(30) Foreign Application Priority Data
Aug. 19, 2011 (SE) 1100600-4

(51) Int. Cl. B31B 3/00

(52) U.S. Cl. CPC B31B 3/00
USPC 53/452; 53/564

(57) ABSTRACT

A method for producing a secondary package, comprising a separate lid and tray, for encasing primary packages, the method comprises folding the lid from a first blank, comprising long side areas along a length of the blank and, at each of opposite short ends of the blank, two cuts are made forming two side flaps and a side cover, separated by the cuts, and folding a tray from a second blank, comprising side areas along a length of the blank. The method comprises folding the side areas of the first blank to form long lid sides; placing the second blank onto a substantially horizontal support rail, between operation flaps; thereby folding the side areas of the second blank to form long tray sides; loading the tray with primary packages; applying the lid to the primary packages, with the long lid sides between the primary packages and the long tray sides.

### TECHNICAL FIELD

This invention pertains in general to the field of packaging. More particularly the invention relates to a cardboard packer for secondary packages, used to group and ship articles already packaged in primary packages, and a method for operating said cardboard packer.

### BACKGROUND

Secondary packaging apparatuses, e.g. a cardboard packer, for packaging primary packages, e.g. cardboard-based milk packages, in a secondary package comprising a tray and a lid, are known in the art.

Document DE 4334760 A1 discloses a foldable packaging container having a bottom plate and extending sides and front walls of a base tray, made of cardboard. The side and front walls are folded up at an angle to the bottom plate to form a frame. The side walls are provided with bent tabs which project therefrom. A lid has inwardly protruding lid tabs which, in the position of use, are hooked onto the bent tabs of the base tray, thus engaging the package.

However, since the base tray and the lid are folded separately and then subsequently put together, there is a risk of poor fit between them. Also, adjusting the exact size of the foldable packaging container is troublesome, which may lead to a poor fit between the packaging container and its content.

Thus, there is a need for a new secondary package, providing better fit and easier adjustment abilities.

Also, an apparatus for providing such secondary package would be advantageous and in particular an apparatus allowing for increased flexibility, quality, user friendliness and/or cost-effectiveness would be advantageous.

### SUMMARY

Accordingly, the present invention preferably seeks to alleviate or eliminate one or more of the above-identified deficiencies in the art and disadvantages singly or in any combination and solves at least the above mentioned problems by providing an apparatus, a method and a secondary package according to the appended patent claims.

The general solution according to the invention is to fold cardboard blanks using the content, i.e. primary packages, as a dolly to ensure that the folding is correct and apply them in a specific order.

According to aspects of the invention, a method, an apparatus and a secondary package are disclosed, whereby a lid blank is folded around primary packages, i.e. primary packages as a dolly.

According to a first aspect of the invention, a method for producing a lid for secondary package is provided, wherein said secondary package comprising a separate lid and tray, encasing primary packages, e.g. cardboard-based milk packages, wherein said method comprises folding the lid from a first cardboard blank, comprising side areas along a length of the blank, the long side areas have been separated from the main area by cuts along the ends of the length of the blank, which creates side flaps and folding a tray from a second cardboard blank, comprising side areas along a length of the blank and the method comprises the steps of: folding the side areas of the first cardboard blank to form long lid sides; placing the second cardboard blank onto a substantially horizontal support rail, in between operation flaps, extending upwards substantially vertical from the support rail, thereby folding the side areas of the second cardboard blank to form long tray sides; loading the tray with primary packages; and applying the lid to primary packages with the long lid sides between the primary packages (92) and the long tray sides.

This is advantageous, since the lid folded with the primary packages as dolly, will be supported by the packages, which facilitates correct folding. Also, the lid will not collide with primary packages when applied over them and the tray will hold the lid in position.

The step of applying the lid to the primary packages may comprise the steps of moving the operation flaps from a closed position, being perpendicular to the length of the support rail, into an open position, being tilted away from the primary packages, such as about 5°, thereby creating a space between the primary packages and the long tray sides; inserting the long lid sides into the space; and moving the operation flaps from the open position to the closed position, thereby securing the long lid sides in a position between the primary packages and the long tray sides.

The method may further comprise the steps of folding side flaps towards each other, against the primary packages, so that the side flaps are substantially perpendicular, at a 90° angle, in relation to the long side edges, to form short sides; applying an adhesive to the surface of the side flaps facing away from the primary packages; and folding a side cover over the side flaps.

This is advantageous, since the lid folded with the primary packages as dolly, will be supported by the packages, which facilitates correct folding. Also, the lid will not collide with primary packages when applied over them.

According to another aspect of the invention, an apparatus for producing a secondary package is disclosed, said secondary package comprising a separate lid and tray, encasing primary packages, said apparatus comprising a lid folder for forming a lid, and a tray folder for forming a tray; said tray folder comprising means for moving or allowing to move the tray sides between a closed and an open position, so that, in use, a first cardboard blank is folded to a lid by the lid folder and a second cardboard blank is folded to a tray by the tray folder, and the lid sides may be inserted between the tray sides and the primary packages, when the tray sides are in the open position and held in place between the tray sides and the primary packages, when the tray sides are in the closed position.

The folding unit may comprise folding assemblies facing the picking unit, when the picking unit is in the position adjacent the folding unit.

The folding assemblies may be mounted on a folding carrier.

This is advantageous, since the distance between the folding assemblies may be varied.

The folding carrier may comprise holding means of the folding unit.

This is advantageous, since the proximity of the suction cup to a folding bracket of the folding assembly will provide a firm hold of the cardboard blank close to the point of folding, i.e. the folding assembly.

The folding carriers may be mounted on a rail.

This is advantageous, since the distance between the folding assemblies may be varied.

The folding unit, may comprise a vertical transport arm, attached to a number of hanging rods, which are aligned substantially parallel to a base level, defined by a lowest point of all folding brackets, and substantially perpendicular to the central axis of the vertical transport arm, and wherein the hanging rods penetrate two side plates, which side plates are slidable along the length of the hanging rods, and which side plates are releasably fixated in an optional position on the hanging rods.

This is advantageous, since the width of the folding unit may then be adjusted by moving the side plates in relation to each other.

The tray folder may comprise a substantially horizontal support rail and operation flaps, extending upwards substantially vertically from the support rail, mounted on a transport track so that the operation flaps may be moved along the support rail.

This is advantageous, because the trays may then be easily moved during folding.

The operation flaps may be mounted on the transport track via a pivot, attached to the transport track so that the operation flaps may pivot between a closed position, being perpendicular to the length of the support rail, and an open position, being about 5° tilted from the closed position.

This is advantageous, since the tray folder may then both provide a firmly held tray, when the operation flaps are in a closed position, and a loosely held tray, when the operation flaps are in an opened position.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which

FIGS. 1 to 3 are flowcharts of methods according to embodiments;

FIGS. 4A and 4B are illustrations showing a lid folder according to an embodiment where FIG. 4A is a perspective view and FIG. 4B is a side view;

FIGS. 5A, 5B and 6 are illustrations showing a folding unit according to an embodiment, where FIG. 5A is a view from one side, FIG. 5B is a view from another side, and FIG. 6 is a view from below;

FIGS. 7A, 7B and 7C are illustrations showing a tray folder according to an embodiment, where FIG. 7A is a perspective view, FIG. 7B is a view from one side and FIG. 7C is a view from another side;

FIG. 8 is an illustration of a cardboard blank according to an embodiment; and

FIG. 9 is an illustration showing folding of a secondary package according to an embodiment.

### DESCRIPTION OF EMBODIMENTS

Several embodiments of the present invention will be described in more detail below with reference to the accompanying drawings in order for those skilled in the art to be able to carry out the invention. The invention may, however, be embodied in many different forms and should not be construed as limited to the embodiments set forth herein. Rather, these embodiments are provided so that this disclosure will be thorough and complete, and will fully convey the scope of the invention to those skilled in the art. The embodiments do not limit the invention, but the invention is only limited by the appended patent claims. Furthermore, the terminology used in the detailed description of the particular embodiments illustrated in the accompanying drawings is not intended to be limiting of the invention.

The following description focuses on an embodiment of the present invention applicable to a secondary package and in particular to a cardboard secondary package with a separate tray and lid. However, it will be appreciated that the invention is not limited to this application but may be applied to many other packages as will be appreciated by a person skilled in the art.

The apparatus described herewith, may suitably be used in a larger packaging system, such as a system for packaging fluid products for subsequent shipping, which will be obvious to a person skilled in the art.

A secondary package according to an embodiment of the invention is formed in the following way. A tray blank is folded, using a folding mechanism, along crease lines such that a tray, comprising a tray bottom and tray side walls, is formed. Then, primary packages are loaded onto the tray bottom during which operation flaps are holding the tray side walls in an erected position. After loading, the flaps release the tray side walls which are then striving outwards due to the stiffness of the cardboard. A lid comprising a lid top and lid side walls are placed over the primary packages, inside the release tray flaps. The lid is formed by folding a lid blank, using a folding mechanism, along crease lines such that a lid, comprising a lid top and lid side walls is formed.

Finally, glue is applied to the outside of the lid side walls before the tray side walls are forced back, by the flaps, into the erected position. When the tray side walls are in the upright position, the lid side walls are stuck between the primary packages and the tray side walls. Thus, when the glue dries, the lid and the tray adhere to each other so as to form a frame. The tray side walls and the lid side walls are then glued so that they close the secondary package. Thereby, a tray with four side walls holding the lid in place between the primary packages and the tray side walls is formed. This will be described further below.

Lid Folder

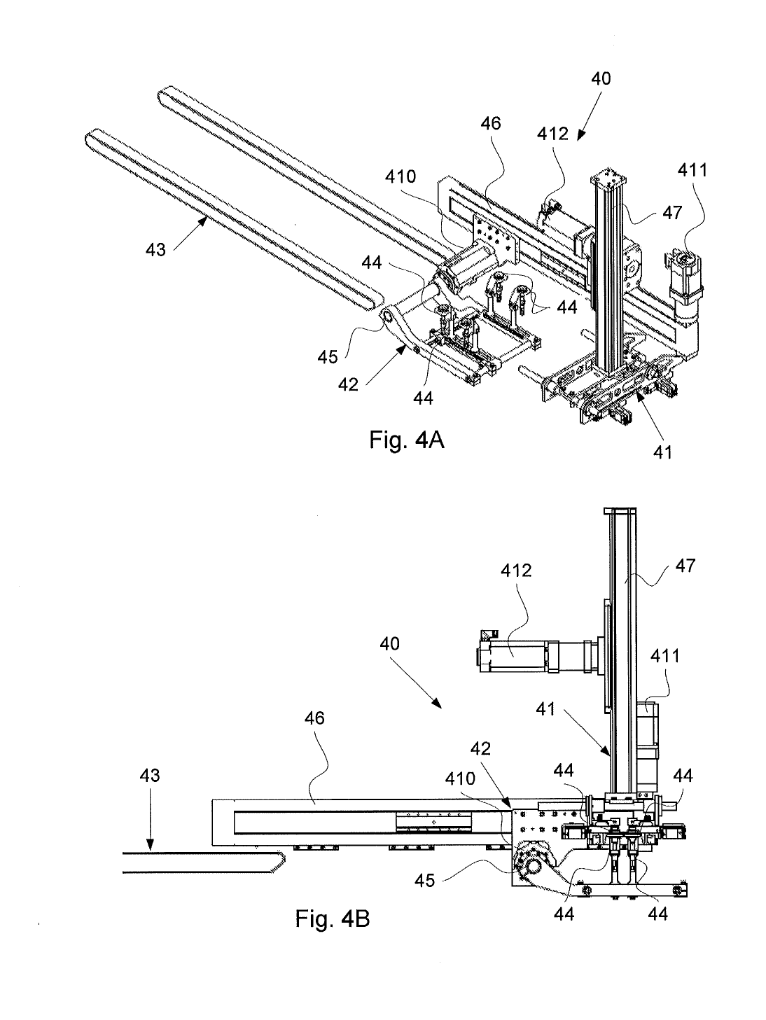

In an embodiment of the invention according to FIG. 4, lid folder 40 is disclosed. FIG. 4A is a perspective view and FIG. 4B is a side view. The lid folder comprises a folding unit 41 and a picking unit 42. Both the folding unit 41 and the picking unit comprises holding means for holding a lid blank (not shown) so that it may be moved from a magazine 43 and processed by the lid folder 40. In this embodiment, the holding means are suction cups 44. The picking unit 42 picks a lid blank (not shown) from the magazine 43 by rotating around an axis 45, from the position displayed in FIG. 4 to a position (not shown) where the suction cups 44 of the picking unit 42 faces the cardboard blanks positioned in the magazine 43. The rotation is accomplished by means of a first electric motor 410, in a way obvious to a person skilled in the art. Throughout the description, it will also be obvious to a person skilled in the art that instead of an electric motor, other suitable means may be used, such as pistons, pneumatic and/or hydraulic, etc. When in contact with a cardboard blank, the suction cups 44 apply an under pressure, thus holding the cardboard blank attached to the picking unit 42 so that the cardboard blank is picked from the magazine 43 when the picking unit 42 rotates back around the axis 45, to its starting position.

The picking unit 42 is movably mounted on a horizontal transport arm 46, so that it can move on the transport arm 46 between a position adjacent to the magazine 43 (as shown in FIG. 4A) and a position adjacent to the folding unit 41 (as shown in FIG. 4B), thereby moving cardboard blanks between the magazine 43 and the folding unit 41. The movement is accomplished by means of a second electric motor 411, in a way obvious to a person skilled in the art.

The folding unit 41 and the picking unit 42 are positioned in a way so that in use, when the picking unit 42 is adjacent to the folding unit 41 (as shown in FIG. 4B), the cardboard blank can be transferred between the picking unit 42, which is holding the cardboard blank by applying under pressure through the suction cups 44, and the folding unit 41 by first applying an under pressure to the suction cups 44 of the folding unit 41 and then releasing the under pressure of the suction cups 44 of the picking unit 42. Thus, the cardboard blank is held attached to the folding unit 41 while being released from the picking unit 42.

After delivering a first cardboard blank (not shown), as disclosed above, the picking unit can be moved along the horizontal transport arm 46 to a position adjacent to the magazine 43 (as shown in FIG. 4A), rotate around the axis 45 and in a repetitive fashion pick up a second, third, fourth etc. cardboard blank (not shown) as described above, for subsequent transportation to the folding unit 41.

The folding unit 41 is mounted on a vertical transport arm 47, so that it can move between a position adjacent to the picking unit 42 (as shown in FIG. 4B), the folding position, and a position adjacent to the primary packages where the lid is to be applied, the application position (not shown), thereby first folding the cardboard blank to form a lid (not shown) and secondly applying the lid to primary packages. The movement is accomplished by means of a second electric motor 412, in a way obvious to a person skilled in the art. In this embodiment, the direction of movement between the first and the second position of the folding unit 41 is perpendicular to the direction of movement of the picking unit 42, when the picking unit 42 is moving between the position adjacent to the magazine 43 (as shown in FIG. 4A) and the position adjacent to the folding unit 41 (as shown in FIG. 4B).

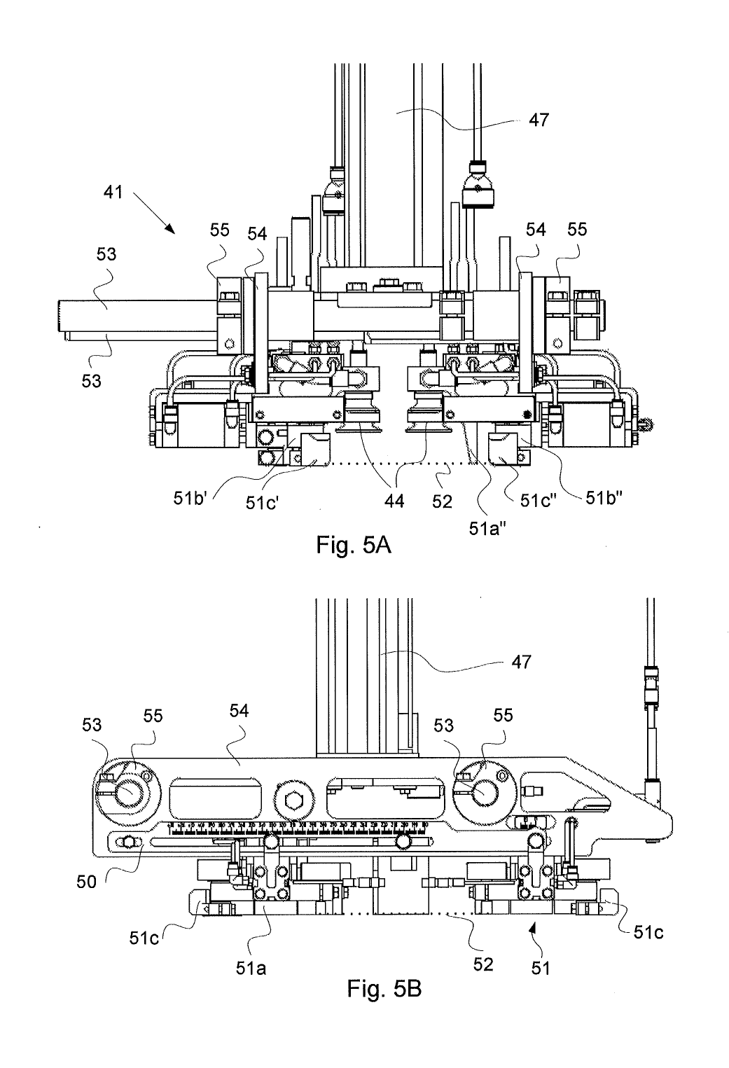

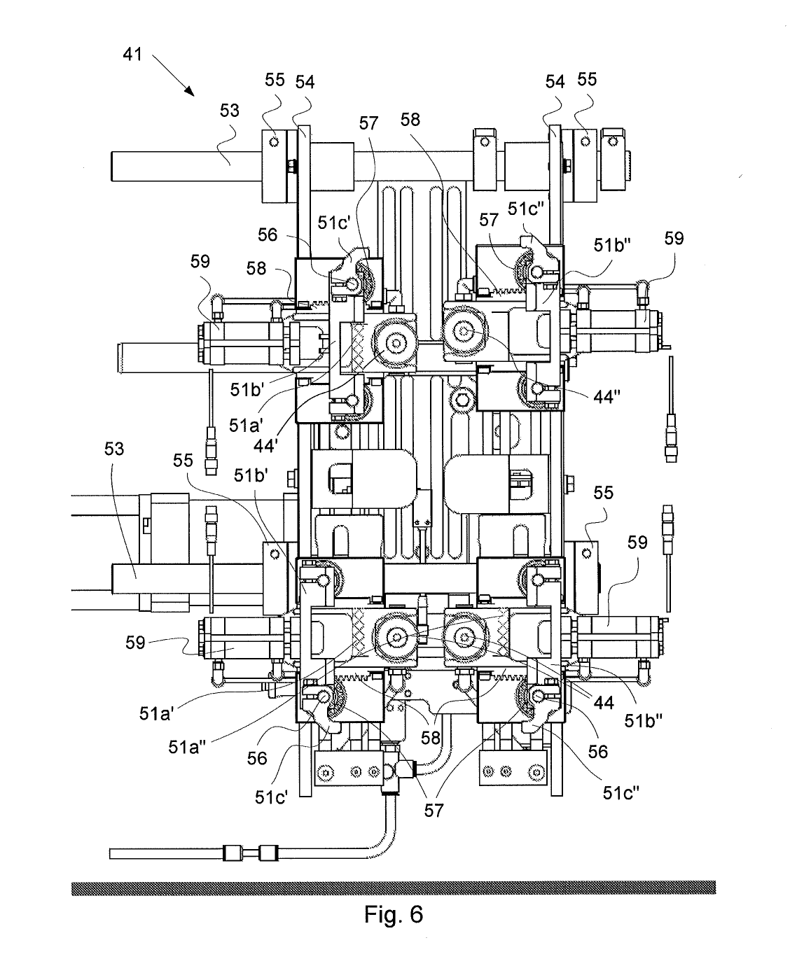

The folding unit 41, according to this embodiment, will now be described in more detail with reference to FIGS. 5 and 6.

A front view of the folding unit 41 is shown in FIG. 5A. As already explained above, the folding unit 41 comprises holding means for holding a lid blank. In this embodiment, the holding means are suction cups 44. Furthermore, the folding unit 41 is mounted on a vertical transport arm 47, so that it can move between a position adjacent to the picking unit 42 (as shown in FIG. 4B), the folding position, and a position adjacent to the primary packages where the lid is to be applied, the application position (not shown), thereby firstly folding the cardboard blank to form a lid (not shown) and secondly applying the lid to primary packages.

The folding unit 41 also comprises folding assemblies 51, which are aligned at a base level 52 (dotted line), which is an imaginary plane drawn up by the exterior surfaces of the folding assemblies 51 facing the picking unit 42, when the picking unit is in the position adjacent the folding unit 41. The folding assemblies 51 comprise a folding bracket 51a, a folding slide 51b and a folding finger 51c.

In the shown embodiment, the folding bracket 51a is (adjustably) fixed to the folding unit, the folding slide 51b can slide between an inoperative position (retracted) and an operative position (extended), and the folding finger 51c is pivotably mounted to the folding slide 51b, and moves between an open and a closed position when the folding slide 51b moves between the inoperative and the operative position. The folding bracket 51a is in the shown embodiment angled slightly outward from the center of the folding unit 51, as can be seen in FIG. 5A.

The suction cups 44 of the folding unit 41 are positioned at a perpendicular distance from the base level 52, which creates a folding space. The folding space can be seen in FIG. 5A as the rectangular shaped space between the suction cups 44 and the base level 52 (dotted line).

In use, a cardboard blank is folded in the folding space, when it is transferred from the picking unit 42 to the folding unit 41. The folding is, on one hand, caused by the pulling force of the suction cups 44 of the folding unit 41, combined with the pushing force of the picking unit 42, and on the other hand the pushing force of the folding brackets 51a, acting at the base level 52.

Thus, the lid folder is using a stamp/pad principle. When folding the cardboard blank, the picking unit 42 is stamping the cardboard blank towards the folding unit 41, which is used as a pad, especially the folding brackets 51a. Since the cardboard blank is pressed into the folding space, a folding is obtained.

An advantage with this is that folding may be ensured in a way, not sensitive to the quality of the card board material, such as with a cardboard material that is very stiff.

Since the lid folder is adapted to fold boxes, i.e. objects with certain symmetry, the construction of the folding unit 41 also shows a certain amount of symmetry. The vertical transport arm 47 is attached to a number of hanging rods 53, which are aligned substantially parallel to the base level 52 and substantially perpendicular to the central axis of the vertical transport arm 47. The hanging rods 53 penetrate two side plates 54, which side plates 54 may slide along the length of the hanging rods 53. The side plates 54 may be releasably fixated in an optional position on the hanging rods 54 by plate securing means 55, in this embodiment a clamp, secured to the side plate 54 and traversed by the hanging rod 53, which clamp may be released or tightened with a screw. On each of the side plates 54, folding assemblies 51 are releasably fixated in certain positions.

This is advantageous, since the distance between the folding assemblies 51 may be varied.

Each folding assembly 51 is mounted on a folding carrier, which according to this embodiment also comprises suction cup 44.

This is advantageous, since the proximity of the suction cup 44 to the folding assembly 51 will provide a firm hold of the cardboard blank (not shown) close to the point of folding, i.e. the folding assembly 51.

At least one of the folding carriers is mounted on a rail 50 and may slide in this rail 50 along the length of the side plate 54.

This is advantageous, since the distance between the folding assemblies 51 may be varied.

FIG. 6 is a view of the folding unit 41 from below, i.e. from the side which in use is adjacent to the picking unit 42. Since the distance between folding units may be adjusted partly by adjusting the positions of the side plates 54 along the length of the hanging rods 53, and partly by adjusting the position of the folding carrier in each rail of the side plates 54, the size of the folding space, which is an imaginary rectangle limited by one folding unit in each corner, can be varied. Thus, the folding unit 41 may be adjusted to accommodate several types of cardboard blanks, and provide folding into different sized lids.

In use, the folding unit 41 provides folding of cardboard blanks in two steps. The first step, folding of the long side of the lid, is obtained by the stamp/pad principle as described above, i.e. when the cardboard blank is transferred from the picking unit 42 to the folding unit 41. This folding of the long side takes place between the folding brackets 51a, mounted on the same side plate 54. The second step, folding of the short side of the lid, is obtained between the folding fingers 51c′ and 51c″ mounted opposite each other on different side plates 54.

Each folding finger 51c is movably mounted on a pivot 56, which has a cogwheel 57. A cogged rack 58, mounted to the folding unit 41, interacts with the cogwheel 57, when the folding slide 51b is regulated by an air pressure unit 59 in a way known to a person skilled in the art. As the folding slide 51b is moved to the operative position, the rack 58 will turn the cogwheel 57 and cause the flap folding finger 51c to pivot around the pivot axis 56 from an open position (as shown in FIG. 6) to a closed position, moved 90° towards the center of the folding space (not shown).

In use, when the folding fingers 51c move from the open position to the closed position, the short edges of the lid are formed, which will be explained further below.

Tray Folder

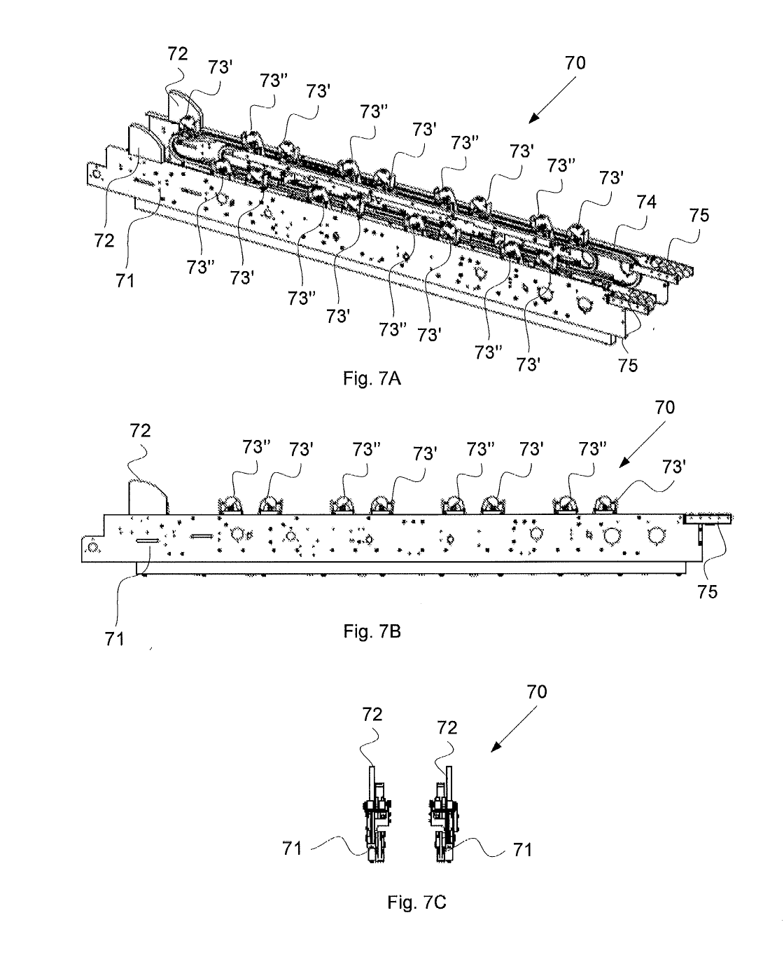

In an embodiment of the invention according to FIG. 7, a tray folder 70 is disclosed. FIG. 7A is a perspective view, FIG. 7B is a side view of the length of the tray folder 70 and FIG. 7C is a side view of the width of the tray folder 70.

Like the folding unit 41 described above, the tray folder has certain symmetry. It comprises two support rails 71, which are mirroring each other and positioned in parallel, so that a support is provided for cardboard blanks while they are being folded and loaded with primary packages.

The support rail 71 comprises a tray loading support 72, which guides the cardboard blank (not shown), by letting the cardboard blank slide along the tray loading support 72 onto the support rail 71, when this is transferred to the support rail 71 from a magazine (not shown). As will be appreciated by a person skilled in the art, this may be done by a picking unit (not shown) in a manner similar to what was described above regarding picking of cardboard blanks to feed the lid folder. Thus, tray cardboard blanks may be picked by a picking device utilizing holding means, such as suction cups applying an under pressure, thus holding the cardboard blank attached to the picking unit so that the cardboard blank is picked from the magazine and delivered to the support rail 71, aided by the tray loading support 72.

The first step of folding the tray, folding of the long side of the tray, is achieved directly when the cardboard blank is delivered to the support rail 71, by the same stamp/pad principle as described regarding the lid folder above. In the case of the tray folder 70, the support rail 71 is the pad and the picking unit (not shown) is the stamp.

However, in this case, the folding space is created by operation flaps 73, mounted on a transport track 74, which in turn is attached to the support rail 71. As will be appreciated by a person skilled in the art, the operation flaps 73 are mounted on the transport track 74 via a pivot (not shown), attached to the transport track 74, so that the operation flaps 73 may pivot, such as by means of an air pressure piston (not shown), between a closed position, being perpendicular to the length of the support rail 71, and an open position, being about 5° tilted from the closed position.

The operation flaps 73 are alternately mounted on the transport track 74 along the support rail 71 in pairs, so that the first operation flap in a pair 73′ pivots in one direction along the length of the support rail 71 and the second operation flap 73″ in the pair pivots in the opposite direction along the length of the support rail.

Thus, in use, when the operation flaps 73 move from the open position to the closed position, each pair of operation flaps 73′, 73″ act as claw clutches for the cardboard blank which has been placed between them by applying holding forces when being in the closed position.

This is advantageous, since the holding forces caused by the operation flaps 73′, 73″ are evenly distributed on two, opposite, sides of the tray.

The second step of folding the tray, folding of the short side of the tray, is obtained by side operation flaps (not shown), which, as will be appreciated by the person skilled in the art, may be mounted opposite each other on different support rails 71 in a pivotable manner like the operation flaps 73.

In use, when the side operation flaps (not shown) move from the open position to the closed position, the short edges of the lid are folded.

The trays are moved along the support rail 71 by the transport track 74, which is driven in a fashion obvious to a person skilled in the art, such as by an electric motor, from the side of the length of the support rail 71 with the loading support 72 to the other side of the length of the support rail 71, whereupon roller bearings 75 are mounted.

As will be explained below, different stages of operation occurs at different locations along the support rail 71.

The cardboard blank used to fold a secondary carton may be any kind of cardboard material, as will be appreciated by the person skilled in the art. The design of the cardboard blank may be any kind of design, suitable for folding with a long side and a short side, as appreciated by the person skilled in the art.

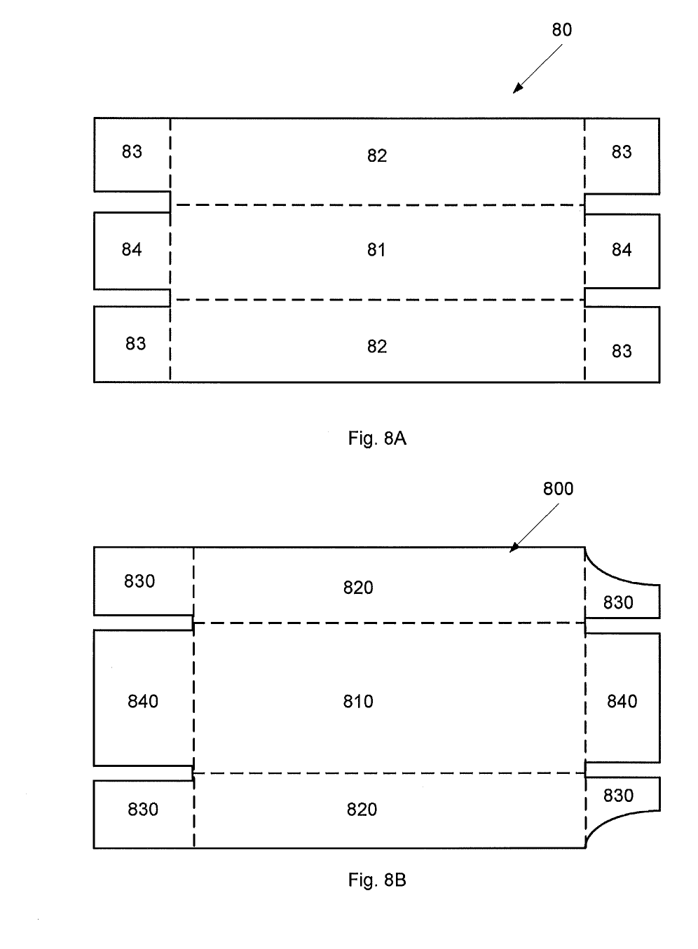

In an embodiment according to FIG. 8, a cardboard blank design is provided. The cardboard blank is planar with two sides, called the long sides, having long ends, extending along a first axis in the plane and two sides, called the short sides, having short ends, extending along a second axis in the plane, which second axis is perpendicular to the first axis. FIG. 8A is a top view of a first cardboard blank 80 design for a lid and FIG. 8B is a top view of a second cardboard blank 800 design for a tray. Dotted lines are provided to mark the lines along which folding takes place.

In general, both the lid and the tray has a main area 81, 810, which will form the top 81 or bottom 810, respectively, of the finished secondary package. Each cardboard blank 80, 800 also have long side areas 82, 820, on each side of the main area 81, 810. At each of opposite short ends of the cardboard blank 80, 800, two cuts are made forming two side flaps 83, 830 and a side cover 84, 840, separated by the cuts. As will be understood by a person skilled in the art, even though the above is described in relation to long and short edges, respectively, the cardboard blank design is also applicable to a square geometric shape, i.e. where all edges are equally long.

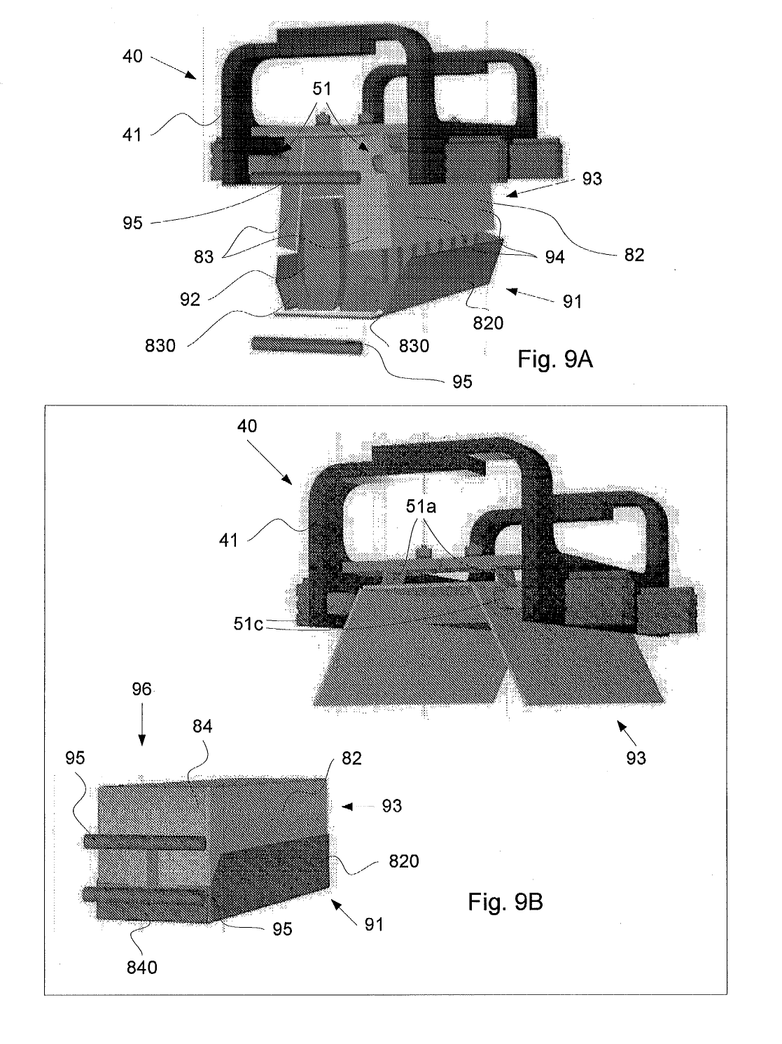

FIG. 9A shows a step in the process of folding a tray 91, from the second cardboard blank, the tray blank, for holding primary packages 92. The tray 91 is adapted to form a pair with a lid 93, folded from the first cardboard blank, the lid blank, and adapted to be paired with a tray 91 to form a secondary package for primary packages 92. This is accomplished by means of the folding unit 40 and the tray folder 70.

Tray Folding

In an embodiment, tray folding is performed to produce a tray 91 for secondary package, said secondary package comprising a separate lid, such as a lid 93 produced according to embodiments of the invention, and tray, encasing primary packages 92. A tray may be folded from a second cardboard blank 800, comprising side areas 820 along a length of the blank. The second cardboard blank 800 may be placed onto a substantially horizontal support rail 71, in between operation flaps 73′, 73″, extending upwards substantially vertical from the support rail 71, thereby folding the side areas 820 of the second cardboard blank 800 to form long lid sides. Next, the tray is loaded with primary packages 92 whereafter side flaps 830 are folded towards each other, against the primary packages 92 so that they are substantially perpendicular, at a 90° angle, in relation to the long side areas 820, to form short sides. An adhesive may be applied to the surface of the side flaps 830 facing away from the primary packages whereafter a side cover 840 may be folded over the side flaps 830.

As stated above, folding of the tray takes place during different stages of operation, occurring at different locations along the support rail 71. The tray is moved along the support rail 71, held by the operation flaps 73, by movement of the transport track 74 into different stations, which will be explained below.

The first station, the tray station, is where the cardboard blank for the tray is placed on the support rail 71, aided by the tray loading support 72. The cardboard blank may come from a magazine (not shown) and be transported to the rail by a picking unit, which will be appreciated by a person skilled in the art. When the cardboard blank is placed on the support rail 71, the long edges, constituted by the side areas 82, are folded by the operation flaps 73. The operation flaps 73′, 73″ then holds the tray in place, when it is transported along the support rail 71 by the transport track 74. Thus, it is advantageous if the distance between the operation flaps 73′, 73″ is the same as the width, i.e. the short side of, the main area 810 of the tray cardboard blank.

The second station, the loading station, is where the primary packages to be packed are loaded onto the tray. This may be done by sliding the primary packages onto the main area 810 of the tray from a separate surface (not shown), aligned with the support rail 71 on the side of the support rail 71. The sliding is facilitated by the side cover 840, which may act as a bridge between the separate surface and the main area 810. Next, when transporting the tray loaded with primary packages along the support rail 71, the primary packages are secured in position by the side areas 82, held in place by the operation flaps 73′, 73″.

Next, the loaded tray is moved along the support rail 71 to a third station, the folding station. Here, the side flaps 830 are folded against the primary packages so that they are substantially perpendicular, at a 90° angle, in relation to the long side areas 820, to form short sides.

Also, the operation flaps 73′, 73″ are tilted from the closed position to the open position, thereby causing the side areas 82 to separate from the primary packages, which allows for easy application of the lid, which will be explained below.

Next, the loaded tray is moved along the support rail 71 to a fourth station, the gluing station, where glue is applied to the surface of the side flaps 830 facing away from the primary packages. Then, the side cover 840 is folded over the side flaps, to engage the glue, and held there by holding means, as will be obvious to a person skilled in the art. Thus the short side of the tray is formed. According to this embodiment, the holding means are rods 95, applied from the short side of the carton as can be seen in FIG. 9.

In this embodiment, the glue is a melt glue applied by a glue dispenser (not shown), positioned to dispense a proper amount of glue on the side flaps 830 to achieve adhesion between the side flaps 830 and the side cover 840. However, any kind of adhesive, such as any kind of glue, applied in any kind of suitable way, may be used in the invention. All this will be easily appreciated by a person skilled in the art.

The loaded and glued tray is then moved along the support rail 71 to a fifth station, the holding station, where the glue is allowed to dry so that the secondary package is finalized and ready for distribution.

Finally, the finalized secondary package is moved along the support rail 71 to a sixth station, the delivery station, which is constituted by the roll bearings 75. From the delivery station, the secondary packages are transported for shipping.

Packaging

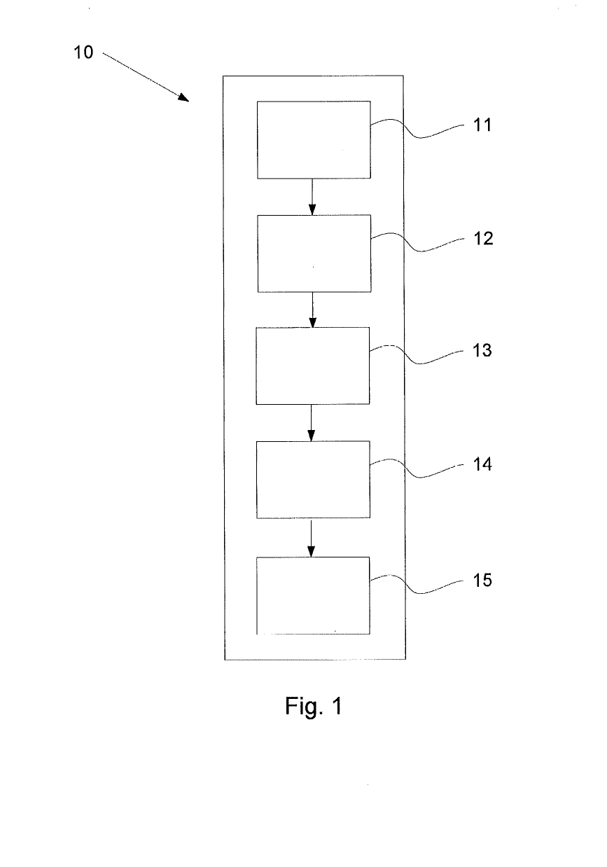

In an embodiment, a secondary package is produced according to a method, which method steps are provided in the flow chart according to FIG. 1.

Thus, FIG. 1 provides a method 10 for producing secondary package. Said secondary package comprises a separate lid and tray, intended to encase primary packages. A lid may be folded from a first cardboard blank 80, comprising long side areas 82 along a length of the blank 80 and, at each of opposite short ends of the blank 80, two cuts are made forming two side flaps 83 and a side cover 84, separated by the cuts, and folding a tray from a second cardboard blank 800, comprising side areas 820 along a length of the blank. The method 10 comprises a step of folding 11 the side areas 82 of the first cardboard blank 80 to form long lid sides. Next, the method 10 comprises a step of applying placing 12 the second cardboard blank 800 onto a substantially horizontal support rail 71, in between operation flaps 73′, 73″, extending upwards substantially vertical from the support rail 71; thereby folding 13 the side areas 820 of the second cardboard blank 800 to form long tray sides. Next, the method comprises a step of loading 14 the tray with primary packages 92 and a step of applying 15 the lid to primary packages 92 with the long lid sides between the primary packages 92 and the long tray sides.

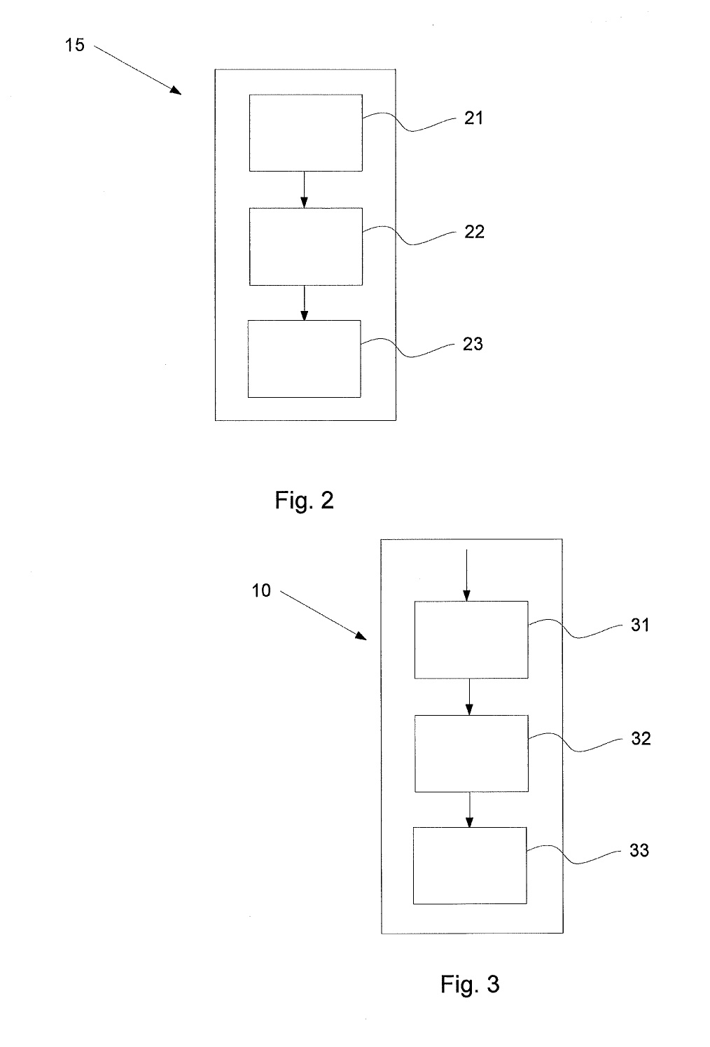

In an embodiment according to FIG. 2, the abovementioned step of applying 15 the lid to the primary packages 92 is divided into sub steps. First, the operation flaps 73′, 73″ are moved 21 from a closed position, being perpendicular to the length of the support rail, into an open position, being tilted away from the primary packages 92, which is described above. This results in a space, created between the primary packages 92 and the long tray sides. The long lid sides may then be inserted 22 into the space, whereupon the operation flaps 73′, 73″ may be moved 23 from the open position to the closed position, thereby securing the long lid sides in a position between the primary packages 92 and the long tray sides. The lid's long sides 82 are angled slightly outwardly, by the folding bracket 51a, such that the lid can easily be placed on top of the primary packages to be packaged. The final folding of the lid's long sides is carried out by the operation flaps 73′, 73″, acting on the tray's long sides.

In an embodiment according to FIG. 3, some further, optional method steps of the method 10 are shown. The side flaps 83, 830 may be folded 31 towards each other, against the primary packages 92, so that the side flaps 83, 830 are substantially perpendicular, at a 90° angle in relation, to the long side areas 82, 820, to form short sides. The method 10 may also comprise a step of applying 32 an adhesive to the surface of the side flaps 83, 830 facing away from the primary package and, finally, a step of folding 33 the side cover 84, 840 over the side flaps 83, 830.

When the tray is in the first and the second station, the cardboard blank which will ultimately form the lid for the respective tray, the lid blank, is picked by a picking unit 42 and moved to the folding unit 41, where the long areas are folded as the lid blank is transferred from the picking unit 42 to the folding unit 41. The long edges, constituted by the side areas 82, are folded when the cardboard blank engages the folding brackets 51a under the pressure from the picking unit 42. FIG. 9B shows the (lid) cardboard blank 91, when held by the folding unit 41.

When the tray is in the third station, the side flaps 83 of the lid blank are folded against the primary packages 92 when the folding fingers 51c, to pivot around the pivot axis from an open position (as shown in FIG. 9B) to a closed position, moved 90° towards the center of the folding space (as shown in FIG. 9A). Here, the side flaps 83 are folded against the primary packages so that they are substantially perpendicular, at a 90° angle, in relation to the long side areas 82, to form short sides.

The third station of the tray, the folding station, is located along the support rail 71 directly under the lid folder 40. Thus, when the vertical transport arm 47 moves between the position adjacent to the picking unit 42 (as shown in FIG. 4B), the folding position, and the position adjacent to the primary packages, situated on the tray in the third station, the application position the lid is applied to the tray. FIG. 9A shows the lid folder 40 just before it reaches the application position.

The folding bracket 51a is angled slightly outward, from the center of the folding unit, such that the lid's long side areas 82 are also angled slightly outward. The folding slide 51b has straight sections that push side areas of the lid 82 against the packages 92. The straight folding slide 51b is moved from the open position to the closed position, so that it emerges on each side of the folding bracket 51a, in order to push side areas of the lid 82 against the primary packages 92. The folding bracket 51a hence loses contact with the blank at this point, but it is held in place by the folding slide 51b in its closed position.

The side areas 820 of the tray blank have been separated from the primary packages by tilting the operation flaps 73′, 73″ from the closed position to the open position. The tray side areas are then striving outwards due to the stiffness of the cardboard. Thus, the lid 93 can be applied against the primary packages 92 between the primary packages 92 and the tray 91. Before the lid 93 is brought into the application position, glue 94 is applied to the surface of the long side areas 82 of the lid blank, facing away from the primary packages 92. Then, when the lid 93 has been moved into the application position, so that the main area of the lid 93 engages the top of the primary packages 92, the operation flaps 73′, 73″ are moved from the open position to the closed position, so that the surface of the long side areas 820 of the tray blank facing the primary packages 92 engages the glue 94, the lid 93 and the tray 91 are joined together into one secondary package. The secondary package is then held by the operation flaps when it travels along the support rail 71 to the remaining stations. Thereby, the glue is allowed to dry.

In this embodiment, the glue is a melt glue applied by a glue dispenser (not shown), positioned to dispense a proper amount of glue on the side flaps 83 to achieve adhesion between the long side areas 82 of the lid and the long side areas 82 of the tray. However, any kind of adhesive, such as glue, applied in any kind of suitable way, may be used in the invention. All this will be easily appreciated by a person skilled in the art.

Since the lid 93 is now joined together with the tray 91, when the loaded tray is moved along the support rail 71 to the fourth station, the gluing station, the lid naturally follows.

Here, glue is applied to the surface of the side flaps 83 of the lid as well as the side flaps 830 of the tray, facing away from the primary packages. Then, the side cover 84, 840, again for the lid as well as the tray, is folded over the side flaps 83, 830, to engage the glue, and held there by holding means, as will be obvious to a person skilled in the art. According to this embodiment, the holding means are rods 95, applied from the short side of the carton as can be seen in FIG. 9.

In this embodiment, the glue is a melt glue applied by a glue dispenser (not shown), positioned to dispense a proper amount of glue on the side flaps 83, 830 to achieve adhesion between the side flaps 83, 830 and the side cover 84, 840. However, any kind of glue, applied in any kind of suitable way, may be used in the invention. Thus, short sides are secured and held in place. All this will be easily appreciated by a person skilled in the art.

The loaded and glued secondary package 96 is then moved along the support rail 71 to a fifth station, the holding station (as shown in FIG. 9B), where the glue is allowed to dry so that the secondary package 96 is finalized and ready for distribution.

Finally, the finalized secondary package 96 is moved along the support rail 71 to a sixth station, the delivery station, which is constituted by the roll bearings 75. From the delivery station, the secondary package 96 is transported for shipping.

Although the present invention has been described above with reference to specific embodiments, it is not intended to be limited to the specific form set forth herein. Rather, the invention is limited only by the accompanying claims and, other embodiments than the specific above are equally possible within the scope of these appended claims.

In the claims, the term “comprises/comprising” does not exclude the presence of other elements or steps. Furthermore, although individually listed, a plurality of means, elements or method steps may be implemented by e.g. a single unit. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A method for producing a secondary package, said secondary package comprising a separate lid and tray, for encasing primary packages, wherein said method includes folding the lid from a first cardboard blank, comprising long side areas along a length of the blank and, at each of opposite short ends of the blank, two cuts are made forming two side flaps and a side cover, separated by the cuts, and folding a tray from a second cardboard blank, comprising side areas along a length of the blank, the method comprises:
folding the side areas of the first cardboard blank to form long lid sides;
placing the second cardboard blank onto a substantially horizontal support rail, in between operation flaps, extending upwards substantially vertical from the support rail; thereby
folding the side areas of the second cardboard blank to form long tray sides;
loading the tray with primary packages; and
applying the lid to the primary packages, with the long lid sides between the primary packages and the long tray sides.

2. The method according to claim 1, wherein the step of applying the lid to the primary packages, comprises:
moving the operation flaps from a closed position, being perpendicular to the length of the support rail, into an open position, being tilted away from the primary packages, thereby creating a space between the primary packages and the long tray sides;
inserting the long lid sides into the space; and
moving the operation flaps from the open position to the closed position, thereby securing the long lid sides in a position between the primary packages and the long tray sides.

3. The method according to claim 2, wherein the tilting is about 5°.

4. The method according to claim 1, further comprising:
folding the side flaps towards each other, against the primary packages, so that the side flaps are substantially perpendicular in relation to the long side areas, to form short sides;
applying an adhesive to the surface of the side flaps facing away from the primary packages; and
folding the side cover over the side flaps.

5. An apparatus for producing a secondary package, said secondary package comprising a separate lid and tray, encasing primary packages, said apparatus comprising a lid folder for folding a lid, and a tray folder for forming a tray; said tray folder comprising means for moving or allowing to move the tray sides between a closed and an open position, so that, in use, a first cardboard blank is folded to a lid by the lid folder and a second cardboard blank is folded to a tray by the tray folder, and the lid sides may be inserted between the tray sides and the primary packages, when the tray sides are in the open position and held in place between the tray sides and the primary packages, when the tray sides are in the closed position.

6. The apparatus according to claim 5, wherein the lid folder includes a folding unit and a picking unit, said folding unit comprising folding brackets facing the picking unit, when the picking unit is in a position adjacent the folding unit.

7. The apparatus according to claim 6, wherein the folding brackets are mounted on a folding carrier.

8. The apparatus according to claim 7, wherein each folding carrier includes a holding means.

9. The apparatus according to claim 7, wherein at least one of the folding carriers is mounted on a rail.

10. The apparatus according claim 8, wherein the holding means are suction cups.

11. The apparatus according to claim 6, wherein the folding unit includes a transport arm, attached to a number of hanging rods, which are aligned substantially parallel to a base level, defined by lowest point of all folding brackets, and substantially perpendicular to the central axis of the vertical transport arm, and wherein the hanging rods penetrate two side plates, which side plates are slidable along the length of the hanging rods, and which side plates are releasably fixated in an optional position on the hanging rods.

12. The apparatus according to claim 5, wherein the tray folder includes a substantially horizontal support rail and operation flaps, extending upwards substantially vertically from the support rail, mounted on a transport track so that the operation flaps may be moved along the support rail.

13. The apparatus according to claim 12, wherein the operation flaps are mounted on the transport track via a pivot, attached to the transport track, so that the operation flaps may pivot between a closed position, being perpendicular to the length of the support rail, and an open position, being about 5° tilted from the closed position.
